(19) United States
(12) Patent Application Publication
(10) Pub. No.: US 2024/0338344 A1
(43) Pub. Date: Oct. 10, 2024

(54) IMAGE FILE CONVERSION METHOD, IMAGE FILE CONVERSION DEVICE, AND PROGRAM

(71) Applicant: FUJIFILM Corporation, Tokyo (JP)

(72) Inventors: Toshiki KOBAYASHI, Saitama-shi (JP); Yuya NISHIO, Saitama-shi (JP); Shoki KASAHARA, Saitama-shi (JP)

(73) Assignee: FUJIFILM Corporation, Tokyo (JP)

(21) Appl. No.: 18/746,328

(22) Filed: Jun. 18, 2024

Related U.S. Application Data
(63) Continuation of application No. PCT/JP2022/043579, filed on Nov. 25, 2022.

(30) Foreign Application Priority Data
Dec. 27, 2021 (JP) 2021-212064

(51) Int. Cl. G06F 16/11; G06V 20/70

(52) U.S. Cl. CPC G06F 16/116; G06V 20/70

(57) ABSTRACT

Provided are an image file conversion method, an image file conversion device, and a program that manage a format of an image file such that various types of additional information can be added.

An image file conversion method includes an acquisition step of acquiring a first image file including image data in which an object has been recorded, a determination step of determining whether or not a first format, which is a file format of the first image file, satisfies a condition in which additional information including information related to the object or information of a right related to the first image file is capable of being added, and a conversion step of converting the first image file into a second image file whose file format is a second format, in which the additional information is capable of being added, in a case where the first format does not satisfy the condition.

### CROSS-REFERENCE TO RELATED APPLICATIONS

This application is a Continuation of PCT International Application No. PCT/JP2022/043579 filed on Nov. 25, 2022, which claims priority under 35 U.S.C. § 119(a) to Japanese Patent Application No. 2021-212064 filed on Dec. 27, 2021. The above applications are hereby expressly incorporated by reference, in their entirety, into the present application.

### BACKGROUND OF THE INVENTION

### 1. Field of the Invention

The present invention relates to an image file conversion method, an image file conversion device, and a program.

### 2. Description of the Related Art

An image file including image data is used for various purposes. For example, in some cases, training data is created from the image file, and machine learning is performed using the training data.

In some cases, additional information related to image data, such as an imaging date and time of an image, an imaging location, imaging conditions, and information of an object, is recorded in the image file (see, for example, JP2010-81453A). The additional information is referred to in a case where the image file is used and is used as, for example, an identification label (correct label) of the image data in the creation of the training data.

### SUMMARY OF THE INVENTION

Whether or not the additional information can be added to the image data and the content of the additional information that can be added are determined according to the file format of the image file.

Meanwhile, in the use of the image file, information of the object reflected in the image data of the image file and information of a right related to the image file, such as authority to use a file, are important. Therefore, the presence or absence of the additional information including these types of information is likely to affect the subsequent use of the image file, and it is possible to more effectively use the image file to which the additional information has been added. Therefore, the file format of the image file to be used needs to be a format in which various types of additional information can be added.

An embodiment of the present invention has been made in view of the above circumstances, and an object of the embodiment of the present invention is to solve the above-described problems of the related art and to provide an image file conversion method, an image file conversion device, and a program that manage a format of an image file such that various types of additional information can be added.

In order to achieve the above object, according to an embodiment of the present invention, there is provided an image file conversion method comprising: an acquisition step of acquiring a first image file including image data in which an object has been recorded; a determination step of determining whether or not a first format, which is a file format of the first image file, satisfies a condition in which additional information including information related to the object or information of a right related to the first image file is capable of being added; and a conversion step of converting the first image file into a second image file whose file format is a second format, in which the additional information is capable of being added, in a case where the first format does not satisfy the condition.

Further, the additional information related to the object may include information related to a type of the object and information related to an attribute of the object or a position of the object in an angle of view of the image data.

In addition, the additional information of the right related to the first image file may include information of whether or not the first image file is capable of being used or modified or information of a right holder related to the first image file.

Furthermore, the first format may have extension information. In this case, in the determination step, it may be determined whether or not the extension information of the first format is the extension information satisfying the condition. Then, in a case where the extension information of the first format is not the extension information satisfying the condition, in the conversion step, the first image file may be converted into the second image file having the extension information satisfying the condition.

Further, the first format may have version information of a standard related to the addition of the additional information. In this case, in the determination step, it may be determined whether or not the version information of the first format is the version information satisfying the condition. Then, in a case where the version information of the first format is not the version information satisfying the condition, in the conversion step, the first image file may be converted into the second image file having the version information satisfying the condition.

In addition, the image file conversion method may further comprise an output step of extracting a frame image from video image data and outputting an image file including the image data of the frame image. Then, in a case where the image data of the first image file is the video image data and the first format does not satisfy the condition, in the output step, an image file whose file format is the second format may be output.

In addition, the image file conversion method may further comprise an addition step of adding the additional information to the first image file, the addition step being executed in a case where the first format satisfies the condition.

Further, the image file conversion method may further comprise an addition step of adding the additional information to the second image file.

Furthermore, the image file conversion method may further comprise a decision step of deciding an item of the additional information to be added to the image file in the addition step.

Moreover, in a case where the additional information is capable of being added for a plurality of the items, in the decision step, one mode may be selected from at least two modes among a mode in which the additional information is added for the item designated by a user, a mode in which the additional information is added for a predetermined item, and a mode in which the additional information is added for all of the plurality of items. In this case, in the addition step, the additional information may be added according to the selected one mode.

In addition, in the addition step, the additional information for a new item set at a second time point after a first time point may be added to the image file to which the additional information was added at the first time point.

Further, an addition mode in which related information related to the added additional information is added to the image file to which the additional information has been added may be selectable. In a case where the addition mode is selected, the related information related to the additional information added for a target item may be added.

Furthermore, in the addition step, history information related to the addition of the additional information may be added as the additional information to the image file.

Moreover, in a case where the additional information includes refusal information for refusing a change in the additional information, the addition step for information corresponding to the refusal information in the additional information may not be executed.

In addition, the image file conversion method may further comprise a setting step of setting a range of the object, to which the additional information is added in the addition step, in an angle of view of the image data.

Further, in the setting step, the range may be set on the basis of an in-focus position in image capture.

Furthermore, according to another embodiment of the present invention, there is provided an image file conversion device comprising a processor. The processor is configured to execute: an acquisition process of acquiring a first image file including image data in which an object has been recorded; a determination process of determining whether or not a first format, which is a file format of the first image file, satisfies a condition in which additional information including information related to the object or information of a right related to the first image file is capable of being added; and a conversion process of converting the first image file into a second image file whose file format is a second format, in which the additional information is capable of being added, in a case where the first format does not satisfy the condition.

Moreover, according to still another embodiment of the present invention, there is provided a program causing a computer to execute each of the acquisition step, the determination step, and the conversion step included in the image file conversion method according to the embodiment of the present invention.

### BRIEF DESCRIPTION OF THE DRAWINGS

FIG. 1 is an explanatory diagram illustrating an image file.

FIG. 2 is a diagram illustrating an example of a data structure of JPEG

FIG. 3 is an explanatory diagram illustrating additional information related to an object.

FIG. 4 is an explanatory diagram illustrating position information of an object region having a circular shape.

FIG. 5 is a diagram illustrating a hierarchical structure of the additional information related to the object.

FIG. 6 is an explanatory diagram illustrating additional information related to image quality.

FIG. 7 is an explanatory diagram illustrating history information.

FIG. 8 is an explanatory diagram illustrating refusal information.

FIG. 9 is a block diagram illustrating a configuration of an image file conversion device according to an embodiment of the present invention.

FIG. 10 is a diagram illustrating a schematic function of the image file conversion device according to the embodiment of the present invention.

FIG. 11 is an explanatory diagram illustrating a detailed function of the image file conversion device according to the embodiment of the present invention.

FIG. 12 is a diagram illustrating a conversion flow.

FIG. 13 is a diagram illustrating a first addition flow.

FIG. 14 is a diagram illustrating a second addition flow.

FIG. 15 is a diagram illustrating an example of a mode selection screen.

FIG. 16 is an explanatory diagram illustrating a set range in an angle of view.

FIG. 17 is an explanatory diagram illustrating an output step.

### DESCRIPTION OF THE PREFERRED EMBODIMENTS

Hereinafter, specific embodiments of the present invention will be described. However, the embodiments described below are only examples for facilitating understanding of the present invention and do not limit the present invention. The present invention can be modified or improved from the embodiments described below without departing from the gist of the present invention. Furthermore, the present invention includes equivalents thereto.

In addition, in the present specification, the concept of “device” includes a single device that exerts a specific function and includes a combination of a plurality of devices that are distributed, are present independently of each other, and exert a specific function in cooperation (operative association) with each other.

Further, in the present specification, a “person” means an agent that performs a specific action, and the concept of the person includes an individual, a group, a corporation, such as a company, and an organization and can further include a computer and a device constituting artificial intelligence (AI). The artificial intelligence implements intellectual functions, such as inference, prediction, and determination, using hardware resources and software resources. An algorithm of the artificial intelligence is optional, and examples thereof include an expert system, case-based reasoning (CBR), a Bayesian network, or a subsumption architecture.

### <<Outline of First Embodiment of Present Invention>>

An embodiment (hereinafter, a first embodiment) of the present invention relates to an image file conversion method, an image file conversion device, and a program that convert an image file.

The image file is created by a known imaging device such as a digital camera. Specifically, the imaging device generates analog image data using an optical signal received from an object in an angle of view and executes a correction process, such as y correction, on digital image data converted from the analog image data. Then, data after the correction process is compressed according to a compression standard adopted by the imaging device to create an image file.

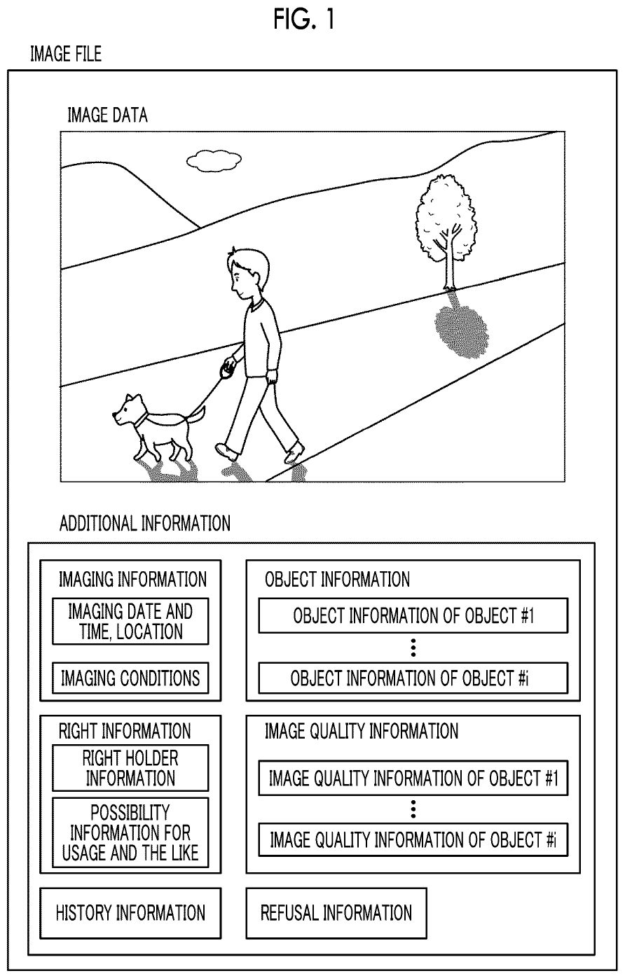

As illustrated in FIG. 1, an image file includes image data in which an object has been recorded. The object of the image data is an object imaged by the imaging device and is present in the angle of view in the image data. In addition, the object is not limited to a specific tangible object and also includes a non-tangible object such as a landscape, a scene, or a pattern.

Further, for the image file created by the imaging device, the image data included in the image file can be edited by a device (hereinafter, an editing device) in which image editing software has been installed. In the following description, the image file generated by the imaging device and the image file edited by the editing device are collectively referred to as an “image file”.

The image file is used for various purposes. For example, the image file may be used for the purpose of creating training data for machine learning. Specifically, the image file is collected to a predetermined collection destination and then annotated (selected) according to a learning purpose. In a case where training data is created from the selected image file and training data required for machine learning is collected, machine learning is performed using the training data.

The image file has a file format corresponding to the data structure thereof. The file format has a file format corresponding to an image file creation standard (specifically, a compression standard) adopted by the imaging device or the like and version information that is updated in the same format.

Examples of the file format include Joint Photographic Experts Group (JPEG), Tagged Image File Format (Tiff), Graphics Interchange Format (GIF), Microsoft Windows bitmap Image (BMP), Portable Network Graphics (PNG), and High Efficiency Image File Format (HEIF). Examples of the format corresponding to JPEG include JPEG File Interchange Format (JEIF), and Design rule for camera file system (DCF). In addition, an example of a standard related to accessory information of JPEG, Tiff, and the like is Exchangeable image file format (Exif).

The file format is reflected in data in the head of the data structure. For example, the JPEG format starts from a marker segment of Start of Image (SOI), and the BMP format starts from BITMAP FILE HEADER which is header information. In addition, the file format has extension information and can be identified by the extension information. The extension information is character string information indicating an extension of a file such as “.jpg”, “.png”, or “.tif”.

The version information is information indicating the number of times (number of updates) a standard related to the addition of additional information, which will be described below, is updated and is represented by a numerical value such as “ver1.0” or “ver2.2”. The version information is written as file management information in the image file.

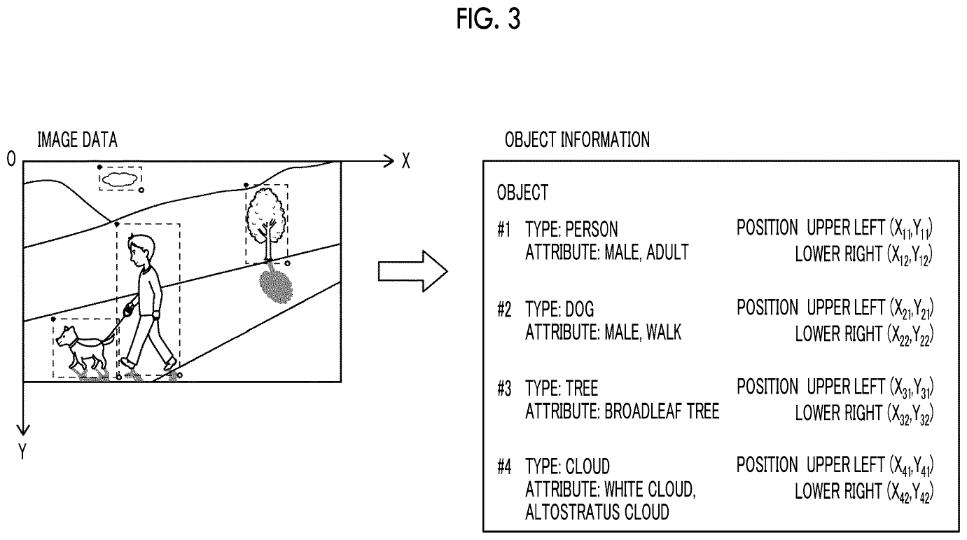

As illustrated in FIG. 1, image files of each format include at least image data. The image data is compressed image data indicating an image captured in the angle of view of the imaging device. Specifically, the image data indicates a resolution, a gradation value of two colors of black and white or three colors of red, green, and blue (RGB), and the like for each pixel. The angle of view is a range in which the image is displayed or drawn in data processing, and the range of the angle of view is defined in a two-dimensional coordinate space having two axes orthogonal to each other as coordinate axes (see FIG. 3).

In addition, the image data may be still image data, video image data, or data of a frame image extracted from the video image data.

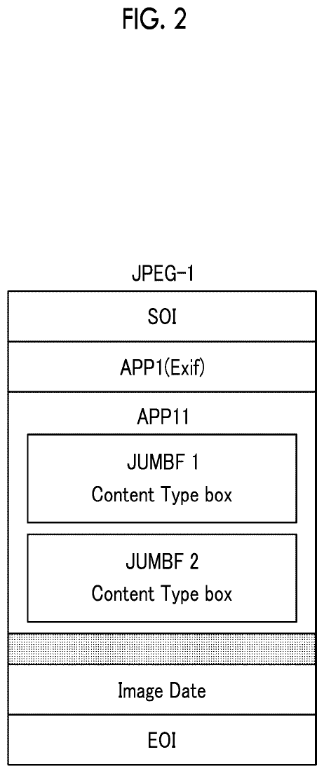

Further, as illustrated in FIG. 1, the image files can include an image file of a format in which additional information can be added (written) to a predetermined region of the image file. A data structure of a JPEG file corresponding to the Exif standard is illustrated as an example of the structure of the image file in FIG. 2. However, the image file according to the present invention is not limited to the JPEG file. In JPEG XT Part 3 which is a kind of JPEG, marker segments “APP1” and “APP11” are provided as regions to which additional information can be added. Tag information related to an imaging date and time of the image data, an imaging location, imaging conditions, and the like is stored in “APP1”. “APP11” includes JPEG Universal Metadata box format (JUMBF) boxes which are metadata storage regions, specifically, JUMBF1 and JUMBF2 boxes. The JUMBF1 box includes a content type box in which metadata is stored, and information can be described in the region of the content type box in a JavaScript Object Notation (JSON) format. A metadata description method is not limited to the JSON format and may be an Extensible Markup Language (XML) format. In addition, in the JUMBF2 box, information different from that in the JUMBF1 box can be described in a content type box. In the JPEG file, it is possible to create about 60000 JUMBF boxes.

Further, in the data structure of Exif ver3.0 (Exif 3.0), a region to which additional information can be added is expanded, specifically, the number of box regions based on JUMBF is increased, as compared to Exif 2.32 which is an old version. A plurality of layers may be set in this box region. In this case, additional information can be stored (written) while the content or the degree of abstraction of the information is changed according to the order of the layers. For example, the type of the object reflected in the image data may be written in a higher layer, and the state, attribute, or the like of the object may be written in a lower layer.

Furthermore, the box region provided in Exif3.0 can also be applied to data structures of file formats, such as Tiff and HEIF, other than JPEG. Strictly speaking, a region corresponding to the box region can be ensured.

For example, the item and number of additional information pieces that can be added to the image file change depending on the file format. In addition, the additional information can be added for a new item by updating the version information of the image file. The item of the additional information means a viewpoint in a case where the additional information is added, simply, the type (category) of the information.

Furthermore, the additional information will be described in detail below.

Meanwhile, the image files can include an image file of a format in which the additional information is not capable of being added (is not capable of being written) and an image file of a format in which a portion of the additional information is not capable of being added. In addition, there may be the following case: in a certain file format, the additional information can be added for a new item by, for example, the update of the version information; and, in another file format, the additional information is not capable of being added for the new item.

In the first embodiment, it is possible to convert an image file of a format in which various types of additional information are not capable of being added into an image file of a format in which the additional information can be added. The utility value of the converted image file is improved by this file conversion. Specifically, for example, since various types of additional information can be added to the image file, it is possible to improve the accuracy of machine learning using the training data created from the image file.

### <<For Additional Information>>

Additional information can be added to an image file of a predetermined file format such as JPEG, Tiff, or HEIF. The additional information will be described with reference to FIGS. 1 to 8. In addition, the additional information illustrated in FIGS. 1 to 8 is only an example. Information not illustrated in the drawings may be added as the additional information, or a portion of the additional information (for example, refusal information, image quality information, or the like) may be omitted.

In a case where the imaging device or the editing device can create an image file of a file format in which the additional information can be added, the additional information may be automatically added to the image file by the function of the imaging device or the editing device. Alternatively, the additional information may be added to the image file by the function of an image file conversion device 10 which will be described below.

The additional information that can be added to the image file includes imaging information, right information, object information, image quality information, history information, refusal information, and the like as illustrated in FIG. 1.

The imaging information is information related to the capture of the image data included in the image file and is, for example, tag information that can be described in a file format such as Exif. The imaging information includes, for example, information related to the imaging date and time and the imaging location and information related to the imaging conditions as illustrated in FIG. 1.

The information related to the imaging date and time and the imaging location includes the season and weather during imaging, the name of the imaging location, illuminance (amount of solar radiation) at the imaging location, and the like.

The information related to the imaging conditions includes information related to the imaging device, information related to exposure conditions, information related to a focus position, and information related to image processing. The information related to the imaging device includes, for example, the manufacturer and model name of the imaging device, the type of a light source included in the imaging device, and the like. The information related to the exposure conditions includes an f-number, ISO sensitivity, a shutter speed, and the like. The information related to the focus position is information indicating a focus position (in-focus position) in the angle of view and is information indicating an auto focus (AF) point in a case where imaging is performed using an auto focus function. The information related to the image processing includes the name of image processing executed on the image data, features of the image processing, a model of a device that has executed the image processing, a region which has been processed in the image data, and the like.

The right information is additional information of a right related to the image file and includes information (hereinafter, right holder information) of a right holder related to the image file and information (hereinafter, possibility information for usage and the like) related to whether or not the image file can be used or modified as illustrated in FIG. 1. Since the right holder information and the possibility information for usage and the like are added as the additional information to the image file, it is possible to appropriately and correctly use the image file according to the information.

The right holder information includes information of a copyright holder of the image data included in the image file or information of a holder of the right to the object (hereinafter, also referred to as an object of the image data for convenience) in the image indicated by the image data. Here, the right to the object of the image data includes a portrait right in a case where the object is a person, a copyright of the object, and the like. In addition, in a case where there is no right holder, the right holder information is information indicating the absence of the right holder such as “no right holder”. In addition, in a case where there is no restriction on the right, the right holder information is information indicating that there is no restriction on the right such as “right-free”.

The possibility information for usage and the like indicates, for example, whether or not the image file can be used for creating training data for machine learning (specifically, annotation for creating training data) or whether or not it is possible to perform the modification of the image data including image editing and the like.

The object information is additional information related to the object of the image data. The object information is added in order to specify or identify the object of the image data. For example, the object information is referred to as a correct label in machine learning using training data created from the image file or is referred to in a case where a desired image is selected from a huge group of images.

At least one or more items are set for the object information. In the first embodiment, a plurality of items can be set, and the object information can be added to the plurality of items. Specifically, in the first embodiment, as illustrated in FIG. 3, information related to the type of the object, the attribute of the object, or the position of the object in the angle of view of the image data can be added as the object information.

Further, in a case where a plurality of objects are present in the image data, the object information is added for each object as illustrated in FIG. 3. In this case, the object information may be added for all of the plurality of objects. Alternatively, the object information may be added for only an object having a large size or only an object located within a designated range (specifically, a set range which will be described below) in the angle of view among the plurality of objects.

As illustrated in FIG. 3, the information related to the position of the object is coordinate information indicating the position of an object region in a two-dimensional coordinate space that defines the angle of view of the image data. The object region is a region that surrounds a portion or all of the object and is specified by the coordinates of a plurality of points on an edge of the object region. Further, the shape of the object region is not particularly limited and may be, for example, a substantially circular shape or a rectangular shape. The user may designate a predetermined range in the angle of view to set the object region, or the object region may be automatically set by a known object detection technique or the like.

In a case where the object region is a rectangular region indicated by a broken line in FIG. 3, the object region is specified by the coordinates of two intersections (points indicated by a white circle and a black circle in FIG. 3) located at both ends of a diagonal line on the edge of the object region. In this case, the coordinates of the two specified points are position information of the object region. Since the object region is indicated by the coordinates of a plurality of points as described above, it is possible to accurately specify the position of the object in the angle of view.

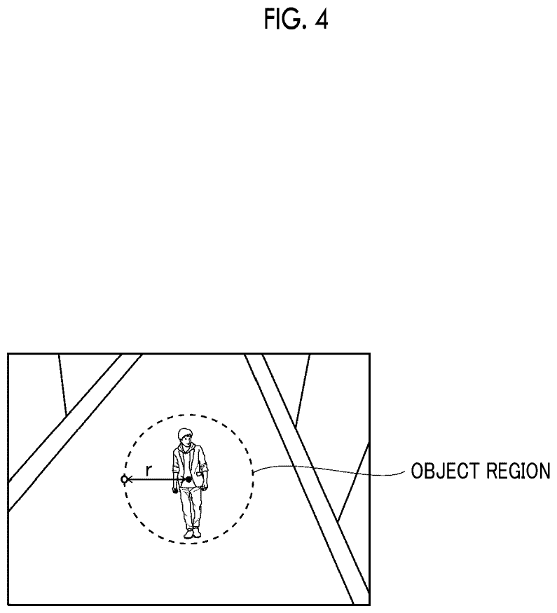

In addition, the object region may be a region that is specified by the coordinates of a base point in the object region and a distance from the base point. For example, in a case where the object region has a circular shape, the object region is specified by the coordinates of the center (base point) of the object region and the distance (that is, a radius r) from the base point to the edge of the object region as illustrated in FIG. 4. In this case, the coordinates of the center, which is the base point, and the radius, which is the distance from the base point, are the position information of the object region. In a case where the base point in the object region and the distance from the base point are used as described above, it is possible to accurately represent the position of the object region.

In addition, the position of the object region having a rectangular shape may be indicated by the coordinates of the center of the region and the distance from the center to the vertex in a direction of each coordinate axis.

The information related to the type of the object is information indicating the type (class) of the object determined on the basis of the feature amount of the object in the image data and corresponds to, for example, a general noun or a proper noun indicating the object.

The information related to the attribute of the object is information indicating the property, feature, state, characteristic, and the like of the object specified on the basis of the feature amount of the object in the image data. Examples of the attribute include appearance features, such as gender, age, an expression, a color, and a size, of the object (person), the presence or absence of scratches or the like, a degree of growth, a degree of damage or deterioration, the content of an action or behavior of the object, and an event in which the object participates.

Further, the information related to the attribute of the object may include information related to the content that is not capable of being identified (determined) only by the appearance (looks) of the object, for example, information related to the presence or absence of an abnormality, such as a disease, or quality, such as a sugar content. This information can be determined from the feature amount of the object in the image data. Specifically, a correspondence relationship between the feature amount of the object and the above-described information may be learned in advance, and the above-described information may be estimated from the correspondence relationship.

In addition, for the type or attribute of the object, a plurality of pieces of additional information may be added to one object while, for example, the degree of abstraction or expression of the information is changed. That is, for an object for which the additional information has been added for at least one item of the object information, related information that is related to the additional information may be added.

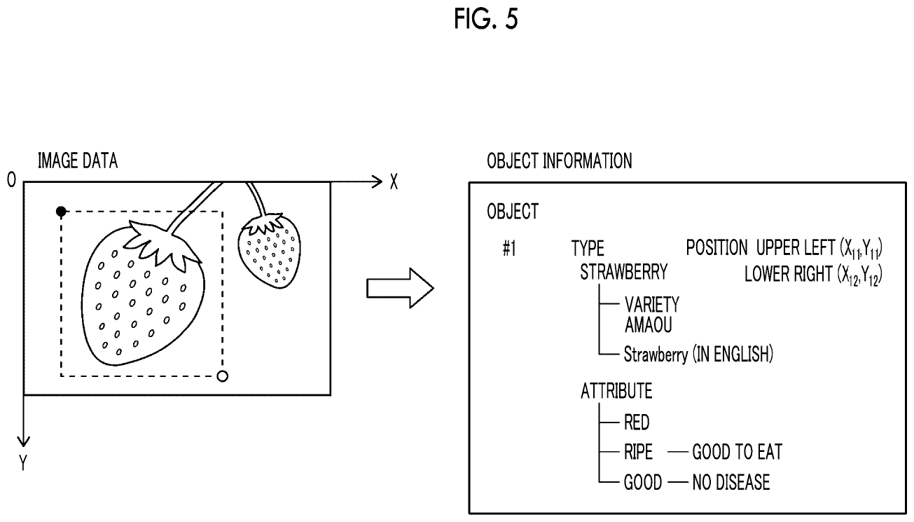

A case illustrated in FIG. 5 will be described as an example. In a case where “strawberry (fruit)” is added as the type of the object, information of a variety which is a more detailed type (subordinate concept), for example, “Amaou” may be added as the related information. In addition, information in which the object of the same type is represented in another language or another expression (for example, a dialect), for example, “Strawberry” in English may be added as the related information. In a case where the additional information related to the attribute of the object is added, information obtained by specifying the additional information or information derived from the additional information may be added as the related information. For example, as illustrated in FIG. 5, in a case where additional information “ripe” indicating the degree of growth of a strawberry is added, related information (derived information), such as “good to cat”, may be added. In addition, in a case where additional information “good” indicating the appearance of the strawberry is added, related information (specified information) “no disease” may be added.

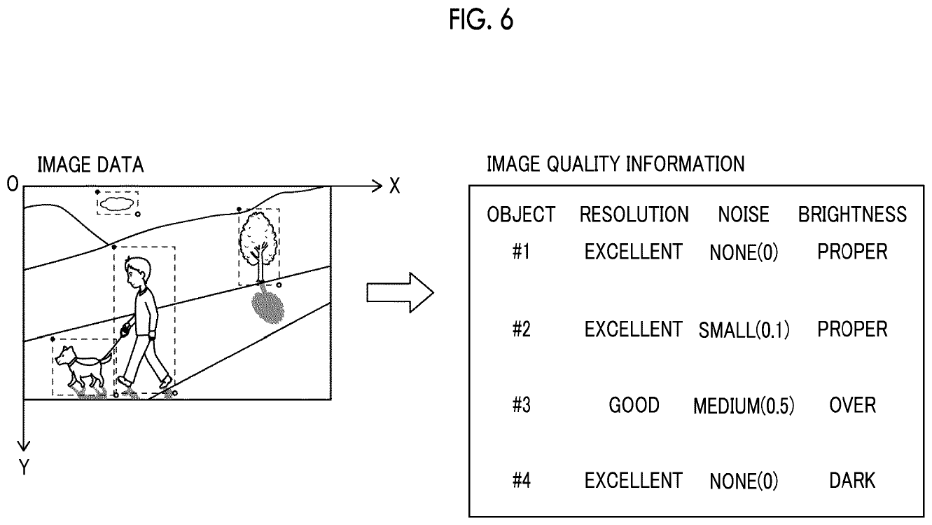

The image quality information is information related to the image quality of the object in the image data and is information related to the sense of resolution, noise, brightness, and the like of the object region as illustrated in FIG. 6. The information related to the sense of resolution corresponds to the presence or absence and degree of blur or shake, a resolution, a grade or rank corresponding thereto, or the like. The information related to the noise corresponds to an S/N value, the presence or absence of white noise, a grade or rank corresponding thereto, or the like. The information related to the brightness corresponds to a brightness value, a score indicating the brightness, a grade or rank corresponding thereto, or the like. In addition, the image quality information may be information indicating an evaluation result (sensory evaluation result) in a case where the sense of resolution, the noise, the brightness, and the like are evaluated on the basis of human sensitivity.

Further, in a case where a plurality of objects are present in the image data, the image quality information is added for each object as illustrated in FIG. 6. In this case, the image quality information may be added for all of the plurality of objects. Alternatively, the image quality information may be added for only some objects (for example, the objects for which the object information has been added) among the plurality of objects.

The image quality information is reflected in the reliability degree (certainty) of the object in the image data. The reliability degree of the image data is higher as the image quality is higher. Therefore, the image quality information can affect the accuracy of machine learning using the training data created from the image file.

The history information is additional information indicating, as a history related to the addition of the additional information (strictly speaking, the additional information excluding the history information), the date and time when the information was added and the file format (specifically, the version information) of the image file at that time point. Further, the history information may include information related to a device or an apparatus that has added the additional information, in addition to the above-described information.

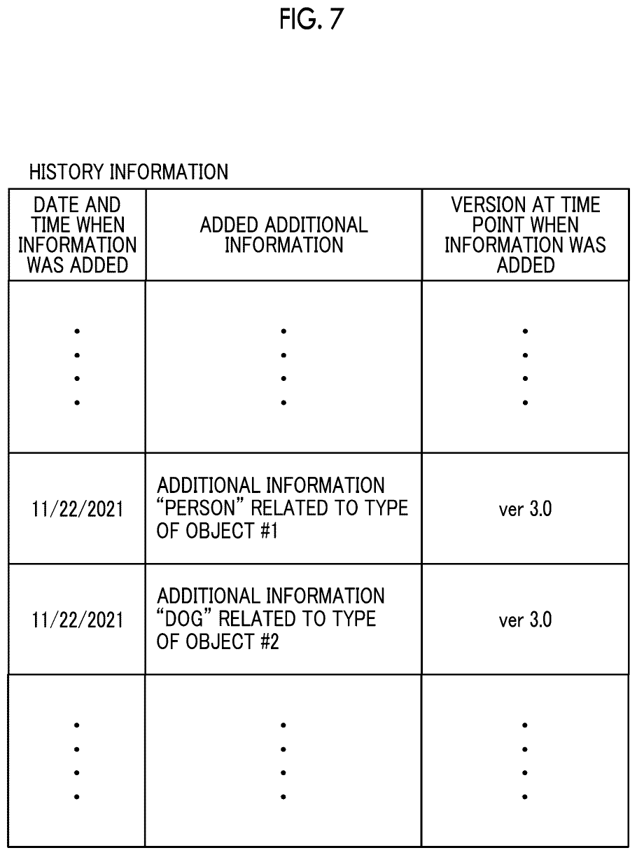

The history information may be individually added for each piece of additional information that has been added to the image file so far, as illustrated in FIG. 7. This makes it possible to easily ascertain when each piece of additional information was added. In addition, the present invention is not limited to the case where the history information is added for each piece of additional information. A plurality of pieces of additional information added at the same time point may be collected as a group, and a single piece of history information may be added for the group. However, even in this case, it is preferable to clarify the correspondence relationship between each piece of additional information and the addition history thereof (that is, the date and time when the information was added and the file format at that time point). Further, the history information may be described in a form of being written together with information (object information) related to the specific type or attribute of the object as illustrated in FIG. 7.

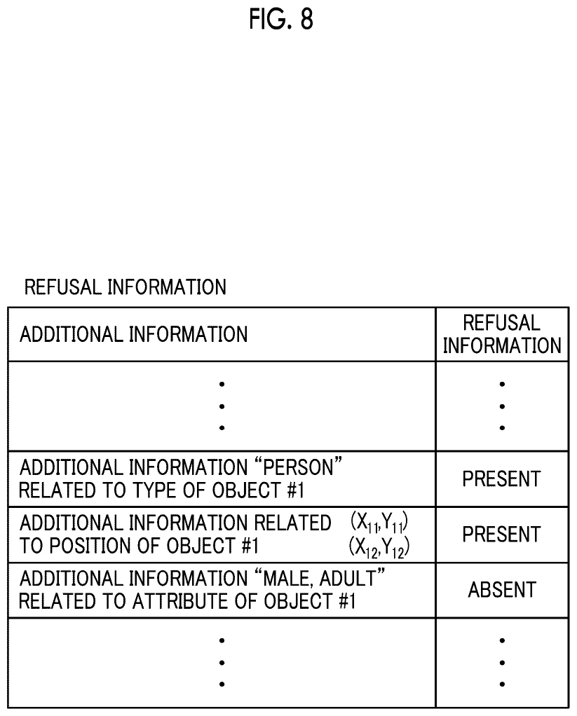

The refusal information is additional information for refusing a change in the additional information. The refusal information is added in order to prevent alteration of the image file and is associated with unchangeable information in the additional information added to the image file as illustrated in FIG. 8. In a case where the refusal information has been added to the image file, information corresponding to the refusal information in the additional information (strictly speaking, the additional information excluding the refusal information) included in the image file is prohibited from being changed. Here, the change in the additional information includes rewriting the additional information, deleting the additional information and replacing the additional information with other additional information, and newly adding additional information such as the above-described related information.

In addition, the present invention is not limited to the case where the refusal information is added in association with the additional information. The refusal information may be added to the image file whose change is to be refused. In this case, a change in the entire image file including a change in the image data and the additional information is restricted. For example, the conversion of the image file into an image file of a different file format is prohibited.

For example, the additional information described above is an example of the additional information in a case where the image data included in the image file is still image data. On the other hand, in a case where the image data is video image data or data of a frame image extracted from the video image data, in addition to the above-described example of the additional information, additional information related to a voice in the video may be further included. The additional information related to the voice includes, for example, information related to a speaker, character information obtained by translating the voice into a language, or information related to the type of the voice (that is, the type of sound source).

### <<For Image File Conversion Device According to First Embodiment>>

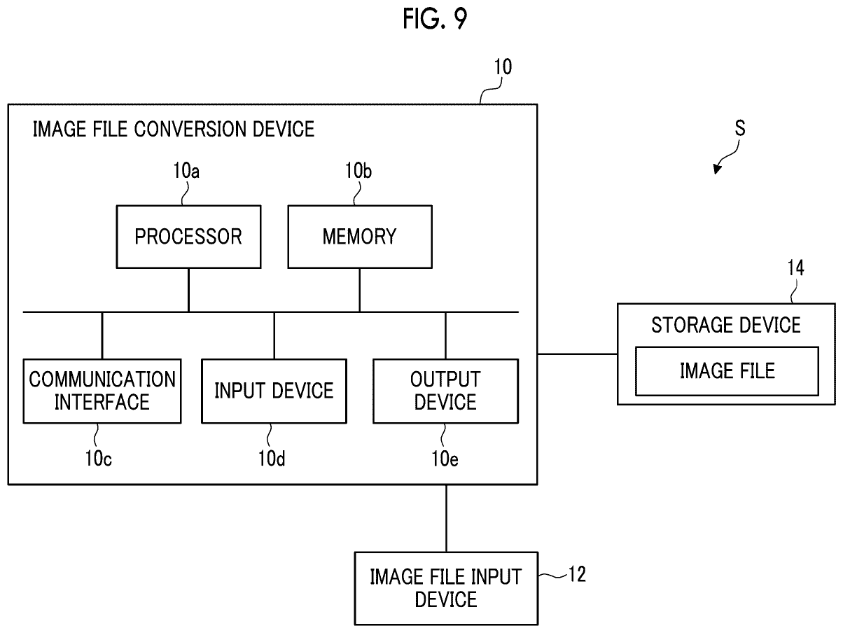

As illustrated in FIG. 9, an image file conversion device (hereinafter, the image file conversion device 10) according to the first embodiment constitutes an image file management system S together with an image file input device 12. In the image file management system S, an image file is created. The image file is converted as necessary, and the created or converted image file is accumulated as a database.

The image files in the database are transmitted to a learning device (not illustrated). An image file corresponding to a learning purpose is selected by annotation by the learning device. Then, in the learning device, training data is created from the selected image file, and machine learning is performed using the created training data.

The image file input device 12 is a device that inputs an image file to the image file conversion device 10 and is, for example, an imaging device or an editing device. Examples of the image file input device 12 include devices owned by individual users, specifically, a digital camera, a communication terminal provided with a camera, and a personal computer (PC) having an image editing function. In addition, examples of the image file input device 12 may include a server computer that accumulates a large number of image files, receives a request from a client terminal, and provides an image file corresponding to the request.

The image file conversion device 10 has a function of converting the image file input from the image file input device 12 as necessary, a function of adding the additional information to the image file, and the like. The image file conversion device 10 is implemented by a processor and a program that can be executed by the processor and is configured by, for example, a general-purpose computer.

The computer constituting the image file conversion device 10 may be a client terminal owned by an individual user, more specifically, a user who uses the image file input device 12. In this case, the image file conversion device 10 may be connected to the image file input device 12 in a wired or wireless manner such that it can communicate therewith. In addition, the image file conversion device 10 may be provided with an image data editing function. That is, image editing software may be installed in the image file conversion device 10.

Further, the computer constituting the image file conversion device 10 may be, for example, a server computer for a cloud service. In this case, the image file conversion device 10 may be connected to the image file input device 12 via an external communication network, such as the Internet or a mobile communication network, such that it can communicate therewith.

As illustrated in FIG. 9, the computer constituting the image file conversion device 10 comprises a processor 10a, a memory 10b, a communication interface 10c, an input device 10d, and an output device 10c.

The processor 10a is configured by, for example, a central processing unit (CPU), a graphics processing unit (GPU), a digital signal processor (DSP), or a tensor processing unit (TPU).

The memory 10b is configured by, for example, a semiconductor memory, such as a read only memory (ROM) and a random access memory (RAM).

The communication interface 10c is configured by, for example, a network interface card or a communication interface board.

The input device 10d is configured by, for example, a keyboard, a mouse, or a touch panel.

The output device 10e is configured by, for example, a display and a speaker.

A program (hereinafter, a file conversion program) for executing a series of information processing related to the conversion of the image file, the addition of the additional information, and the like is installed in the computer constituting the image file conversion device 10. The file conversion program is a program for causing the computer to execute an image file conversion method according to the present invention. That is, the processor 10a reads out the file conversion program and executes the file conversion program such that the computer comprising the processor 10a functions as the image file conversion device according to the present invention.

In addition, the file conversion program may be read from a computer-readable recording medium and acquired. Alternatively, the file conversion program may be received (downloaded) via a communication network, such as the Internet or an intranet, and acquired.

The image file conversion device 10 receives the image file input from the image file input device 12 and stores the image file in a storage device 14. A plurality of image files are accumulated as a database in the storage device 14, and the image file conversion device 10 is configured to read out the image files accumulated in the storage device 14. In addition, the image files accumulated in the storage device 14 can include the image file converted by the image file conversion device 10.

Further, the storage device 14 is, for example, a known storage device and may be mounted on the image file conversion device 10 or may be provided in a third computer (for example, an external server) that can communicate with the image file conversion device 10.

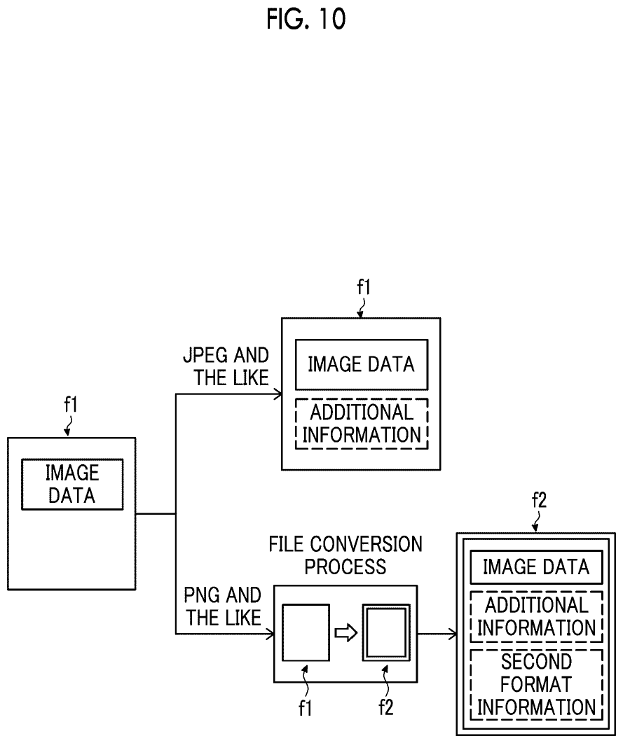

Next, an outline of functions of the image file conversion device 10 will be described with reference to FIG. 10.

The image file conversion device 10 determines whether or not the file format of the image file input from the image file input device 12 satisfies a condition for determination. Here, it is assumed that the image file to be determined is referred to as a “first image file f1” and the file format of the first image file f1 is referred to as a “first format”.

The condition for determination is a condition in which the first format is a file format in which the additional information including the object information or the right information can be added. Examples of the file format satisfying this condition include JPEG, Tiff, and HEIF corresponding to a version (specifically, Exif3.0 or the like) in which the object information or the right information can be added. On the other hand, examples of the file format that does not satisfy the condition for determination include PNG, GIF, BMP, and old versions of JPEG, Tiff, and HEIF that do not correspond to the version in which the object information or the right information can be added.

In addition, “the additional information including the object information or the right information can be added” may include that at least one of the object information or the right information can be added and that both of the two types of additional information can be added.

In a case where the first format satisfies the condition for determination, the image file conversion device 10 can add the additional information including the object information or the right information to the first image file f1 as illustrated in FIG. 10. In this case, at a time point when the first image file f1 is input to the image file conversion device 10, the additional information including the object information or the right information may already be added to the first image file f1. That is, the device that adds the additional information to the image file of the file format satisfying the condition for determination may be a device other than the image file conversion device 10, for example, the image file input device 12.

On the other hand, in a case where the first format does not satisfy the condition for determination, the image file conversion device 10 converts the first image file f1 into a second image file f2 as illustrated in FIG. 10. The second image file f2 is an image file of a file format (hereinafter, referred to as a second format) in which the additional information including the object information or the right information can be added. Then, after the file conversion, the image file conversion device 10 adds the additional information including the object information or the right information to the second image file f2.

In addition, in a case where the image file conversion is performed, the image file conversion device 10 adds second format information to the second image file f2 after the conversion as illustrated in FIG. 10. The second format information is information related to the file format of the second image file f2, that is, the second format. Specifically, the second format information is flag information indicating the file format in which the additional information including the object information or the right information can be added.

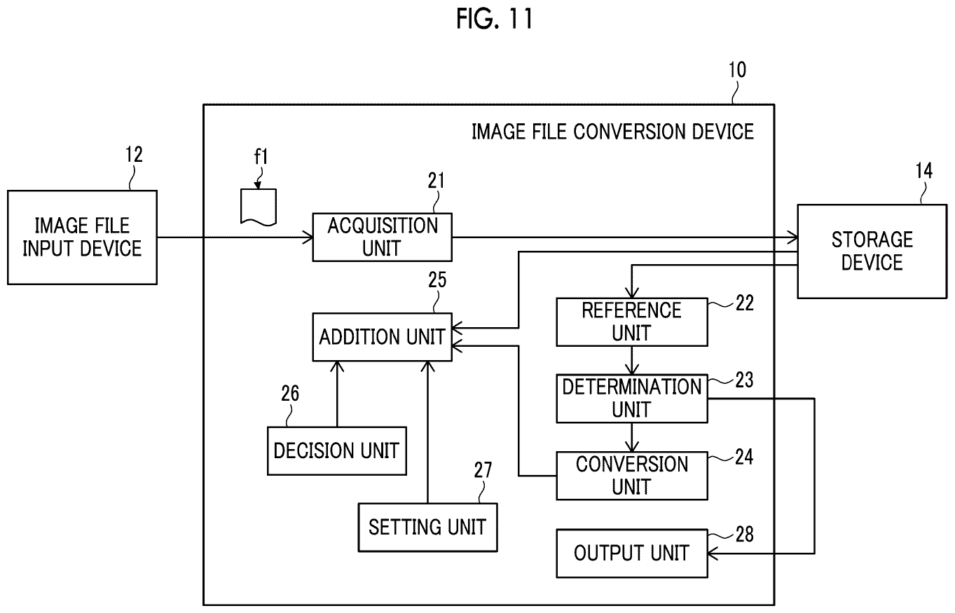

The functions of the image file conversion device 10 will be described in detail with reference to FIG. 11. The image file conversion device 10 includes an acquisition unit 21, a reference unit 22, a determination unit 23, a conversion unit 24, an addition unit 25, a decision unit 26, a setting unit 27, and an output unit 28. These functional units are implemented by cooperation between hardware devices of the computer constituting the image file conversion device 10 and software including the above-described file conversion program.

The acquisition unit 21 executes an acquisition process. In the acquisition process, the acquisition unit 21 receives the image file input from the image file input device 12 to acquire the image file. The image file input from the image file input device 12 is an object to be determined by the determination unit 23 and specifically corresponds to the first image file f1. In addition, the image file (first image file f1) acquired by the acquisition unit 21 is stored in the storage device 14 and is accumulated as a database.

The reference unit 22 executes a reference process. In the reference process, the reference unit 22 refers to the image file accumulated in the storage device 14 as the first image file f1. In this case, the reference unit 22 determines whether or not the image file is the second image file f2 on the basis of the presence or absence of the second format information and excludes the second image file f2 from a reference target.

The determination unit 23 executes a determination process. In the determination process, the determination unit 23 determines whether or not the first format, which is the file format of the first image file f1 referred to by the reference unit 22, satisfies the condition for determination. The determination unit 23 may directly determine whether or not the first format is a file format in which the additional information including the object information or the right information can be added. For example, in a case where flag information indicating whether or not the additional information can be added is set for the first format, the determination unit 23 may determine whether or not the condition is established on the basis of the flag information.

Alternatively, the determination unit 23 may indirectly determine whether or not the first format is a file format in which various types of additional information can be added, on the basis of the extension information or the version information included in the first format. That is, in the determination process, it may be determined whether or not the extension information of the first format described in, for example, the header of each file is extension information satisfying the condition for determination, or it may be determined whether or not the version information of the first format is version information (for example, the version information of Exif) satisfying the condition for determination. As described above, according to the determination based on the extension information or the version information, it is possible to more easily determine whether or not the first format is a file format in which various types of additional information can be added.

The conversion unit 24 executes a conversion process in a case where the first format does not satisfy the condition for determination. In the conversion process, the conversion unit 24 converts the first image file f1 of the first format that does not satisfy the condition for determination into the second image file f2 whose file format is the second format. The second format is a file format in which the additional information including the object information or the right information can be added and has extension information or version information to which the above-described additional information can be added.

That is, in a case where the extension information of the first format is not the extension information satisfying the condition for determination, the conversion unit 24 converts the first image file f1 into the second image file f2 having extension information satisfying the condition for determination. Alternatively, in a case where the version information of the first format is not the version information satisfying the condition for determination, the conversion unit 24 converts the first image file f1 into the second image file f2 having version information satisfying the condition for determination.

In addition, the conversion unit 24 adds the second format information to the second image file f2 after the conversion. Therefore, it is possible to easily recognize that the image file to which the second format information has been added is the second image file f2, that is, that the file format is the second format in which the additional information including the object information or the right information can be added.

The addition unit 25 executes an addition process. In the addition process, the addition unit 25 adds the additional information to the image file. Specifically, in a case where the first format satisfies the condition for determination, the addition unit 25 executes the addition process of adding the additional information to the first image file f1. On the other hand, in a case where the first image file f1 is converted into the second image file f2 because the first format does not satisfy the condition for determination, the addition unit 25 executes the addition process of adding the additional information to the second image file f2. Therefore, it is possible to add various types of additional information including the object information or the right information to each of the image files stored in the storage device 14 and to increase the utility value of the image file.

The additional information is automatically added by the function of the image file conversion device 10 comprising the addition unit 25. Specifically, the feature amount of the object is calculated from the image data, and the additional information corresponding to the calculated feature amount is added. However, the present invention is not limited thereto. The user of the image file conversion device 10 may perform an input operation related to the object, and character information input by the operation may be added as the additional information.

In addition, there may be a case where the additional information can be added for a new item by the update of the image file conversion device 10, the update of the version information of the Exif standard, or the like. In this case, the addition unit 25 adds the additional information for a new item set at a second time point after a first time point to the image file to which the additional information was added at the first time point. The first time point is a time point when the additional information was added to the image file, strictly, a time point when the additional information for the item except for the new item was added. For example, the first time point corresponds to a time point when the addition unit 25 executed the latest addition process.

As described above, in a case where the additional information can be added for a new item by the update of the version information or the like, the addition unit 25 adds the additional information only for the new item to the image file to which the additional information has already been added. Therefore, the amount of information added to the image file is increased, which makes it possible to further increase the utility value of the image file.

In addition, in a case where the addition unit 25 adds the additional information to the image file, the addition unit 25 adds the history information related to the addition as the additional information to the image file. In particular, in a case where the additional information for a new item is added to the image file as in the above-described case, the addition unit 25 adds, as the history information, the time point when the additional information was added, the version information at that time point, and the like. This makes it possible to easily specify when each piece of additional information was added.

Further, in a case where the additional information added to the image file includes additional information whose change is to be restricted, the addition unit 25 adds the refusal information for refusing a change in the additional information to the image file. In a case where the refusal information has been added, an addition process of changing the added information or adding new information is not executed on the additional information corresponding to the refusal information. This makes it possible to avoid, for example, the alteration of the additional information corresponding to the refusal information and to protect the additional information.

The decision unit 26 executes a decision process. In the decision process, the decision unit 26 decides an item of the additional information to be added to the image file by the addition unit 25. In the first embodiment, the additional information can be added for a plurality of items. For example, in a case where the object information is added, the additional information can be added for items such as a type, an attribute, a position, and a related matter. The decision unit 26 decides some or all of the plurality of items as the items of the additional information to be added to the image file.

Specifically, in the first embodiment, three modes can be selected for the items for which the additional information is added. A first mode is a mode (hereinafter, an item designation mode) in which the additional information is added for the item designated by the user. A second mode is a mode (hereinafter, an automatic mode) in which an optimal item is automatically selected from predetermined items, such as items in initial settings or recommended settings, and the additional information is added for the selected item. A third mode is a mode (hereinafter, an all-designation mode) in which the additional information is added for all of a plurality of items. In a case where the user selects one mode from these modes, the decision unit 26 decides the item of the additional information to be added to the image file according to the selected mode.

As described above, since the user decides the item of the additional information to be added to the image file, it is possible to set the amount of information (the amount of additional information) of the image file on the basis of the intention of the user. Further, in the first embodiment, since one of the three modes is selected, it is possible to easily decide the number and type of items for which the additional information is to be added.

Furthermore, the selectable modes are not limited to the three modes, and another mode may be further added. In addition, at least two modes among the three modes may be selected. Alternatively, there may be only one mode for deciding the item of the additional information, and the item may be decided by a method according to the mode.

Moreover, in the first embodiment, an addition mode can be selected in addition to the three modes. The addition mode is a mode, in which related information related to the added additional information is added to the image file to which the additional information has been added, and can be selected even in a case where any one of the three modes has been selected. Then, in a case where the addition mode is selected, the related information (see FIG. 5) is added to the additional information added for a target item. Therefore, the amount of additional information added to the image file is increased, and the utility value of the image file is further increased. In particular, in machine learning using the training data created from the image file, since the amount of information of the image file is increased, the accuracy of learning is improved.

The setting unit 27 executes a setting process. In the setting process, the setting unit 27 sets a range (hereinafter, also referred to as a set range) of the object, to which the additional information is added by the addition unit 25, in the angle of view of the image data. Therefore, in the subsequent addition process, the additional information is added only to the object present within the set range in the angle of view. Since the range of the object, to which the additional information is added, is limited as described above, it is possible to reduce the execution load of the addition process and to avoid an excessive increase in the amount of additional information to be added.

A method for setting the set range is not particularly limited. For example, the set range may be set on the basis of a designation operation of the user of the image file conversion device 10. In addition, the set range may be set on the basis of an in-focus position in image capture, specifically, an AF point in the angle of view. The AF point may be specified from the information of the imaging conditions included in the image file or may be specified by analyzing the image data. Then, a range in the vicinity of a location designated by the user or a range in the vicinity of the AF point may be set as the set range, and the object located within the range may be set as an object to which the additional information is to be added.

Further, in the image data, the range in the vicinity of the AF point is in focus and thus is a clear image. Therefore, in a case where the vicinity of the AF point is set as the set range, it is possible to improve the reliability (accuracy) of the additional information added to the object within the set range.

In addition, in a case where a plurality of objects are present within the set range, the setting unit 27 may set priority for each object. In this case, first to N-th objects (N is an integer equal to or greater than 1) in descending order of the priority may be set as the objects to which the additional information is to be added. Further, the priority may be determined according to the type of the object, the display size (magnitude) of the object in the angle of view, the distance from the center of the set range, or the like.

The output unit 28 executes an output process. In the output process, the output unit 28 extracts a frame image from video image data and outputs an image file including image data of the extracted frame image. The output process is executed, for example, in a case where the image data of the first image file f1 is video image data and the first format does not satisfy the condition for determination. In this case, in the output process, the output unit 28 extracts a frame image from the video image data included in the first image file f1 and outputs, as an image file of the extracted frame image, an image file whose file format is the second format.

As described above, in the first embodiment, various types of additional information can also be added to the image file including the data of the frame image extracted from the video image data. Therefore, it is possible to increase the utility value of the image file including the data of the frame image.

### <<For Procedure of Image File Conversion According to First Embodiment of Present Invention>>

Next, a processing flow of the image file conversion device 10 according to the first embodiment of the present invention will be described. In the processing flow described below, the image file conversion method according to the present invention is used. That is, each step in the processing flow described below corresponds to a component of the image file conversion method according to the present invention.

In addition, the processing flow described below is only an example. Unnecessary steps may be deleted, new steps may be added, or an order in which the steps are executed may be changed, without departing from the gist of the present invention.

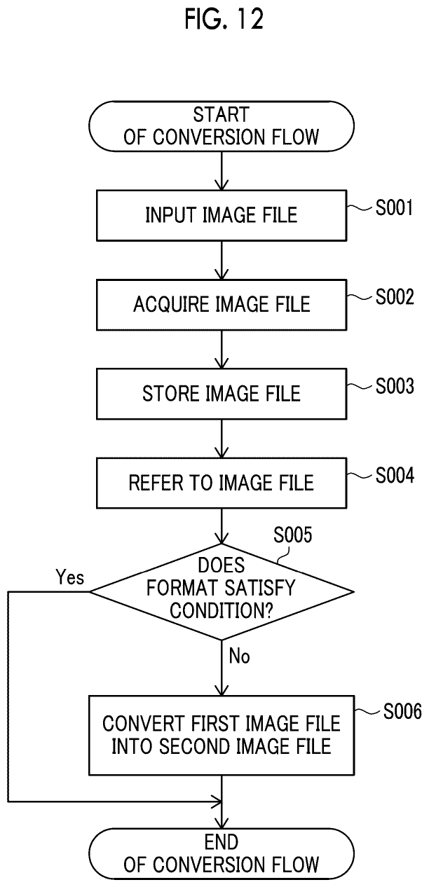

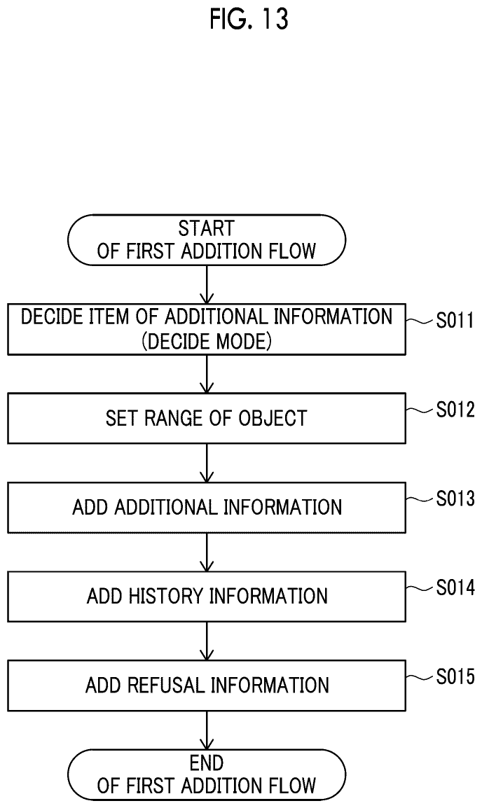

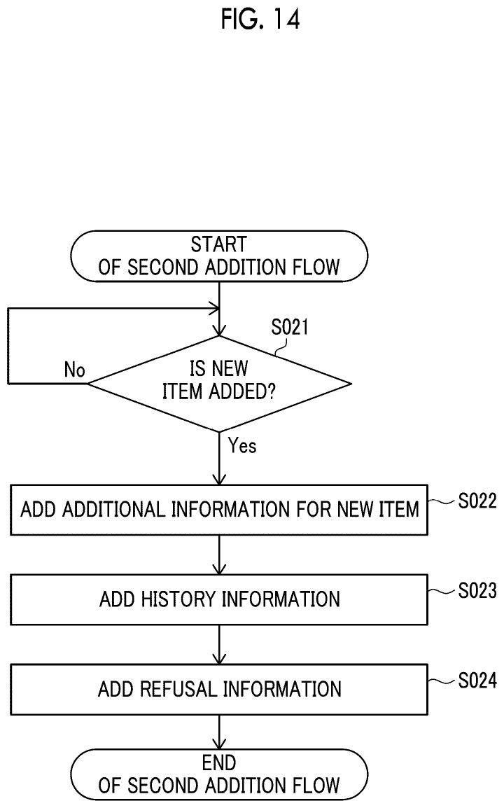

The processing flow by the image file conversion device 10 includes a conversion flow illustrated in FIG. 12, a first addition flow illustrated in FIG. 13, and a second addition flow illustrated in FIG. 14, and these processes are executed in the above-described order. Hereinafter, each processing flow will be described.

### (Conversion Flow)

Each step in the conversion flow is executed by the processor 10a of the image file conversion device 10. That is, the processor 10a reads out the file conversion program and executes a series of processes related to the conversion flow defined in the program.

The conversion flow starts after the input of the image file from the image file input device 12 to the image file conversion device 10 (S001). The processor 10a functions as the acquisition unit 21 and executes the acquisition process. Specifically, the processor 10a receives the input of the image file to acquire the image file (S002). Step S002 corresponds to an acquisition step, and the acquired image file corresponds to the first image file f1.

The image data included in the acquired first image file f1 may be still image data or video image data. Hereinafter, it is assumed that the image data included in the first image file f1 is still image data unless otherwise specified.

The acquired first image file f1 is stored in the storage device 14 and is accumulated as a database (S003). Then, the processor 10a functions as the reference unit 22 and refers to the first image file f1 stored in the storage device 14 (S004). Step S004 corresponds to a reference step. In Step S004, the processor 10a specifies the file format of the first image file f1 to be referred to, that is, the first format. More specifically, the processor 10a specifies, for example, the extension information or the version information included in the first format.

Then, the processor 10a functions as the determination unit 23 and determines whether or not the specified first format satisfies the condition for determination (S005). Step S005 corresponds to a determination step. In Determination Step S005, the processor 10a indirectly determines whether or not the first format is a file format in which the additional information including the object information or the right information can be added, on the basis of the extension information or the version information of the first format. However, the present invention is not limited thereto. The processor 10a may directly determine whether or not the first format is a file format in which the additional information including the object information or the right information can be added.

Then, in a case where the first format does not satisfy the condition for determination, the processor 10a functions as the conversion unit 24 and converts the first image file f1 into the second image file f2 whose file format is the second format (S006). Step S006 corresponds to a conversion step, and the following first addition flow is executed on the second image file f2 after the conversion.

On the other hand, in a case where the first format satisfies the condition for determination, Conversion Step S006 is omitted. In addition, the following first addition flow is executed on the first image file f1 satisfying the condition for determination.

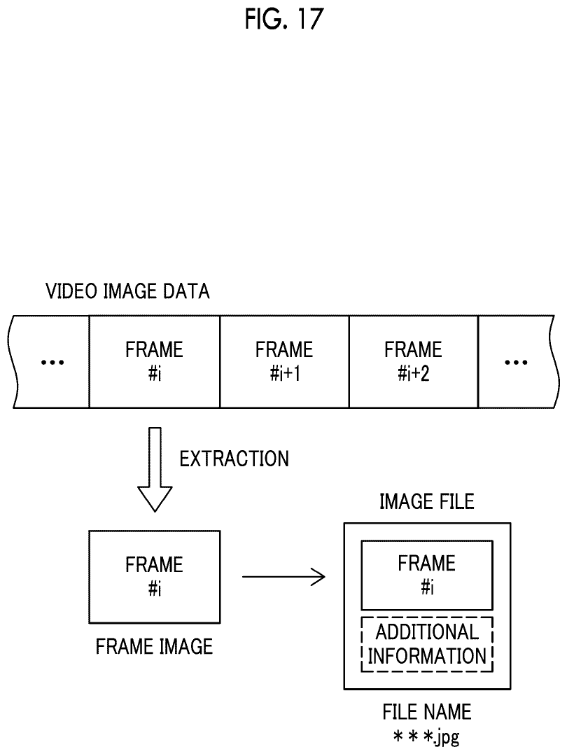

In addition, in a case where the image data of the first image file f1 is video image data and the first format does not satisfy the condition for determination, the processor 10a executes the output process as the output unit 28. A step in which the processor 10a executes the output process corresponds to an output step. In this step, the processor 10a extracts a frame image from the video image data and outputs an image file including image data of the frame image as illustrated in FIG. 17. The file format of the image file output at that time is the second format. That is, the file format has the extension information or the version information to which the object information or the right information can be added. In addition, it is preferable to add the additional information including the object information or the right information to the image file to be output and to output the image file.

### (First Addition Flow)

The first addition flow is started after the conversion flow is ended or is started in response to a start request from the user who uses the image file conversion device 10. Each step of the first addition flow is executed by the processor 10a of the image file conversion device 10. That is, the processor 10a reads out the file conversion program and executes a series of processes related to the first addition flow defined in the program.

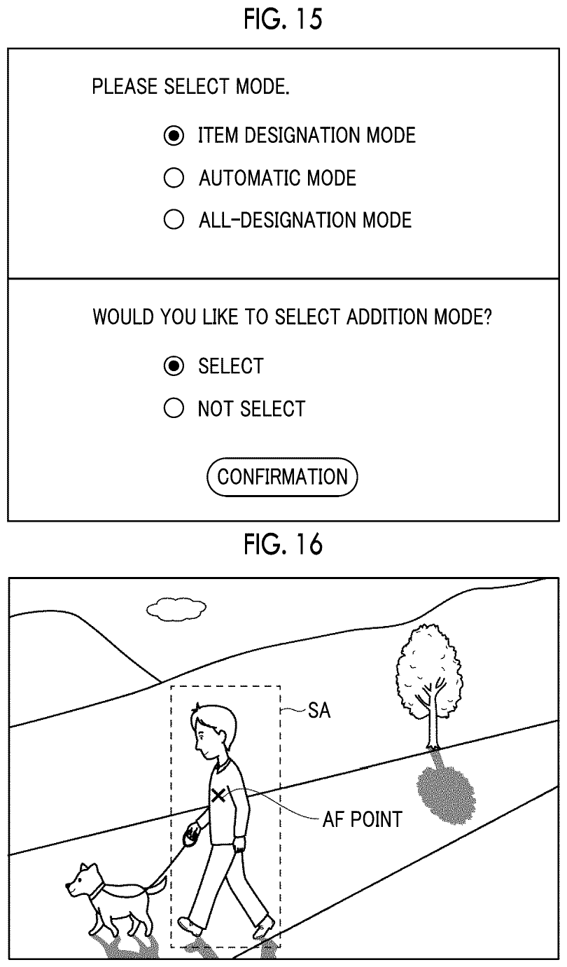

In the first addition flow, first, the processor 10a decides the item of the additional information to be added to the image file in the subsequent Step S013 as the decision unit 26 (S011). Step S011 corresponds to a decision step. In a case where the item is decided, the processor 10a displays a mode selection screen illustrated in FIG. 15 on a display which is the output device 10c. The user of the image file conversion device 10 selects one of the item designation mode, the predetermined item mode, and the all-designation mode through a screen of the display and operates the input device 10d to input the selection result of the mode. The processor 10a receives the input of the user, specifies the mode selected by the user, and decides an item corresponding to the specified mode as the item of the additional information.

In addition, as illustrated in FIG. 15, the addition mode is displayed on the mode selection screen to be selectable. The user selects one mode among the three modes, selects whether or not the addition mode is required, and inputs the selection results with the input device 10d. The processor 10a receives the input of the user and specifies the selection result of the user for whether or not the addition mode is required.

Then, the processor 10a functions as the setting unit 27 and sets the range of the object to which the additional information is added, that is, the set range in the angle of view of the image data included in the image file (S012). Step S012 corresponds to a setting step. In Setting Step S012, the processor 10a may set the vicinity of a designated location as the set range on the basis of a designation operation of the user. Alternatively, the processor 10a may set, as the set range, a range (a range represented by letters SA in FIG. 16) in the vicinity of the AF point (in-focus position) in image capture on the basis of the AF point as illustrated in FIG. 16.

In a case where a plurality of objects are present within the set range, the processor 10a may set priority for each object and set the first to N-th objects in descending order of the priority as the objects to which the additional information is to be added.

In addition, Setting Step S012 may be any step. For example, Setting Step S012 may be executed only in a case where there is a user's instruction or the like. In a case where there is no user's instruction, the execution of Setting Step S012 may be omitted.

Then, the processor 10a functions as the addition unit 25 and adds the additional information to the image file (S013). Step S013 corresponds to an addition step. The image file to which the additional information is added in Addition Step S013 is the first image file f1 satisfying the condition for determination or the second image file f2 converted from the first image file f1 in the conversion flow.

In Addition Step S013, the additional information including the object information or the right information is added to the image file. In this case, the processor 10a adds the additional information for the item decided in Step S011, that is, adds the additional information for the item corresponding to the mode selected by the user. For example, in a case where the item designation mode is selected, the processor 10a adds the additional information for the item designated by the user. Further, in a case where the predetermined item mode is selected, the processor 10a adds the additional information for a predetermined item. In addition, in a case where the all-designation mode is selected, for all of a plurality of items that can be added at the present time, the processor 10a adds the additional information for each item.

Further, the additional information added in Step S012 may include the imaging information or the image quality information.

In addition, in a case where the image data of the image file to which the additional information is added is the image data of the frame image extracted from the video image data, additional information related to a voice may be further added.

Furthermore, in a case where the set range is set in Step S012, the processor 10a limits the object, to which the additional information (object information) is to be added, to the object within the set range in the angle of view of the image data included in the image file.

In addition, in a case where the addition mode is selected, the processor 10a adds the related information related to the additional information added for the target item in Addition Step S013. The target item is an item to which the related information can be added. For example, in a case where the target item is the type of the object, information of the subordinate concept (specifically, a variety or the like) of the type or information representing the type in another language or expression is added as the related information. In addition, in a case where the target item is the attribute of the object, the derived information of the attribute or the specified information of the attribute is added as the related information.

Further, the processor 10a further adds the history information as one piece of additional information to the image file to which the additional information (strictly speaking, the additional information excluding the history information) has been added (S014). The history information indicates the time point when the additional information was added (that is, the execution date and time of Addition Step S013) and indicates the version information of the image file at a time point when the additional information was added.

Furthermore, in a case where the processor 10a adds the history information to the image file, the processor 10a may add the history information for each piece of additional information added to the image file. Alternatively, for a plurality of pieces of additional information added to the same image file at the same timing, the plurality of pieces of additional information may be collected as a group, and a single piece of history information may be added for the group.

In addition, the processor 10a further adds the refusal information for the additional information, whose change is restricted, as one piece of additional information to the image file (S015). In this case, Addition Step S013 is no longer executed on information corresponding to the refusal information in the additional information (strictly speaking, the additional information excluding the refusal information) added to the image file. That is, the additional information corresponding to the refusal information is prevented from being modified or deleted after the information is added, and new additional information (for example, the related information) is prevented from being added thereto.

Further, in a case where there is no additional information that is prohibited from being changed, that is, in a case where there is no additional information to which the refusal information is added, the execution of Step S015 is omitted.

The series of Steps S011 to S015 described above is executed on the image file stored in the storage device 14. Specifically, the additional information is added to the image file, which has been stored (added) in the storage device 14 between the previous first addition flow and the current first addition flow, in the current first addition flow.

### (Second Addition Flow)

The second addition flow is executed after the time point (that is, the first time point) when the first addition flow is executed. More specifically, in a case where the additional information can be newly added for the item, which was not included at the first time point, at the second time point after the first time point, the second addition flow is executed.

Each step of the second addition flow is executed by the processor 10a of the image file conversion device 10. The processor 10a reads out the file conversion program and executes a series of processes related to the second addition flow.

As described above, in a case where a new item is set as the item of the additional information, the second addition flow is started using the setting of the new item as a trigger (S021). In a case where the second addition flow is started, the processor 10a functions as the addition unit 25 and executes an addition process of adding the additional information for the new item to the image file (S022). Therefore, the additional information only for the new item is added to the image file to which the additional information has already been added in the first addition flow.

In addition, in a case where the additional information for the new item is added, the file format of the image file is updated to the version information in which the additional information can be added. That is, in Step S022, the processor 10a converts the image file stored in the storage device 14 into an image file of a file format in which the additional information can be added for the new item.

Then, for the additional information added in Step S022, the processor 10a adds the history information thereof as the additional information to the image file (S023). Further, in a case where the additional information added in Step S022 is prohibited from being changed, the processor 10a further adds the refusal information to the image file in association with the additional information (S024).

The series of Steps S021 to S024 described above is executed on the image file stored in the storage device 14. Furthermore, for the image file to which the refusal information has been added in the first addition flow, in a case where information corresponding to the refusal information in the additional information added to the image file is related to the new item, the execution of Step S022 is omitted.

### Other Embodiments

The embodiment described above is a specific example for describing the image file conversion method, the image file conversion device, and the program according to the present invention in an easy-to-understand manner and is only an example. Other embodiments can also be considered.

In the above-described embodiment, in a case where the first image file f1 satisfies the condition for determination or in a case where the first image file f1 is converted into the second image file f2, the addition process is executed. With this configuration, the additional information is automatically added to these image files. However, the present invention is not limited thereto. The user may designate whether or not the addition of the additional information is required. Specifically, a mode (hereinafter, a non-addition mode) in which the additional information is not added to the image file may be selectable. In a case where the non-addition mode is selected, the additional information that has not been added to the image file may be written to another management file. In this case, the additional information may be stored in the management file in a state of being associated with the image file to which the additional information is to be originally added.

In addition, in a case where the additional information for a new item is not capable of being added to the image file because the refusal information is added to the image file, the additional information may be written to another management file in the same manner as described above.

Further, the processor comprised in the image file conversion device according to the present invention includes various processors. The various processors include, for example, a CPU which is a general-purpose processor that executes software (program) to function as various processing units.

Moreover, the various processors include a programmable logic device (PLD) which is a processor whose circuit configuration can be changed after manufacturing, such as a field programmable gate array (FPGA).

Further, the various processors include, for example, a dedicated electric circuit which is a processor having a dedicated circuit configuration designed to execute a specific process, such as an application specific integrated circuit (ASIC).

Further, one functional unit included in the image file conversion device according to the present invention may be configured by one of the various processors or a combination of two or more processors of the same type or different types, for example, a combination of a plurality of FPGAs or a combination of an FPGA and a CPU.

In addition, a plurality of functional units included in the image file conversion device according to the present invention may be configured by one of the various processors, or two or more of the plurality of functional units may be collectively configured by one processor.

Further, as in the above-described embodiment, one processor may be configured by a combination of one or more CPUs and software and may function as the plurality of functional units comprised in the image file conversion device according to the present invention.

In addition, for example, an aspect may be adopted in which a processor that implements the functions of the entire system including the plurality of functional units of the image file conversion device according to the present invention using one integrated circuit (IC) chip is used. A representative example of this aspect is a system on chip (SoC). Furthermore, a hardware configuration of the various processors described above may be an electric circuit (circuitry) in which circuit elements, such as semiconductor elements, are combined.

### EXPLANATION OF REFERENCES

10: image file conversion device
10a: processor
10b: memory
10c: communication interface
10d: input device
10e: output device
12: image file input device
14: storage device
21: acquisition unit
22: reference unit
23: determination unit
24: conversion unit
25: addition unit
26: decision unit
27: setting unit
28: output unit
f1: first image file
f2: second image file
S: image file management system

What is claimed is:

1. An image file conversion method comprising:
an acquisition step of acquiring a first image file including image data in which an object has been recorded;
a determination step of determining whether or not a first format, which is a file format of the first image file, satisfies a condition in which additional information including information related to the object or information of a right related to the first image file is capable of being added; and
a conversion step of converting the first image file into a second image file whose file format is a second format, in which the additional information is capable of being added, in a case where the first format does not satisfy the condition.

2. The image file conversion method according to claim 1,
wherein the additional information related to the object includes information related to a type of the object and information related to an attribute of the object or a position of the object in an angle of view of the image data.

3. The image file conversion method according to claim 1,
wherein the additional information of the right related to the first image file includes information of whether or not the first image file is capable of being used or modified or information of a right holder related to the first image file.

4. The image file conversion method according to claim 1,
wherein the first format has extension information,
in the determination step, it is determined whether or not the extension information of the first format is the extension information satisfying the condition, and
in a case where the extension information of the first format is not the extension information satisfying the condition, in the conversion step, the first image file is converted into the second image file having the extension information satisfying the condition.

5. The image file conversion method according to claim 1,
wherein the first format has version information of a standard related to the addition of the additional information,
in the determination step, it is determined whether or not the version information of the first format is the version information satisfying the condition, and
in a case where the version information of the first format is not the version information satisfying the condition, in the conversion step, the first image file is converted into the second image file having the version information satisfying the condition.

6. The image file conversion method according to claim 1, further comprising:
an output step of extracting a frame image from video image data and outputting an image file including the image data of the frame image,
wherein, in a case where the image data of the first image file is the video image data and the first format does not satisfy the condition, in the output step, an image file whose file format is the second format is output.

7. The image file conversion method according to claim 1, further comprising:
an addition step of adding the additional information to the first image file, the addition step being executed in a case where the first format satisfies the condition.

8. The image file conversion method according to claim 1, further comprising:
an addition step of adding the additional information to the second image file.

9. The image file conversion method according to claim 7, further comprising:
a decision step of deciding an item of the additional information to be added to the image file in the addition step.

10. The image file conversion method according to claim 9,
wherein, in a case where the additional information is capable of being added for a plurality of the items,
in the decision step, one mode is selected from at least two modes among a mode in which the additional information is added for the item designated by a user, a mode in which the additional information is added for a predetermined item, and a mode in which the additional information is added for all of the plurality of items, and
in the addition step, the additional information is added according to the selected one mode.

11. The image file conversion method according to claim 10,
wherein, in the addition step, the additional information for a new item set at a second time point after a first time point is added to the image file to which the additional information was added at the first time point.

12. The image file conversion method according to claim 7,
wherein an addition mode in which related information related to the added additional information is added to the image file to which the additional information has been added is selectable, and
in a case where the addition mode is selected, the related information related to the additional information added for a target item is added.

13. The image file conversion method according to claim 7,
wherein, in the addition step, history information related to the addition of the additional information is added as the additional information to the image file.

14. The image file conversion method according to claim 7,
wherein, in a case where the additional information includes refusal information for refusing a change in the additional information, the addition step for information corresponding to the refusal information in the additional information is not executed.

15. The image file conversion method according to claim 7, further comprising:
a setting step of setting a range of the object, to which the additional information is added in the addition step, in an angle of view of the image data.

16. The image file conversion method according to claim 15,
wherein, in the setting step, the range is set on the basis of an in-focus position in image capture.

17. An image file conversion device comprising:
a processor,
wherein the processor is configured to execute:
an acquisition process of acquiring a first image file including image data in which an object has been recorded;
a determination process of determining whether or not a first format, which is a file format of the first image file, satisfies a condition in which additional information including information related to the object or information of a right related to the first image file is capable of being added; and
a conversion process of converting the first image file into a second image file whose file format is a second format, in which the additional information is capable of being added, in a case where the first format does not satisfy the condition.

18. A program causing a computer to execute each of the acquisition step, the determination step, and the conversion step included in the image file conversion method according to claim 1.
